(19) United States
(12) Patent Application Publication
(10) Pub. No.: US 2025/0251550 A1
(43) Pub. Date: Aug. 7, 2025

(54) FIBER OPTIC CONNECTOR AND MULTIFIBER FERRULE FOR FIBER OPTIC CONNECTOR

(71) Applicant: Senko Advanced Components, Inc., Hudson, MA (US)

(72) Inventors: Kazuyoshi TAKANO, Tokyo (JP); Shota MIZUKI, Tokyo (JP); Kenji IiZUMI, Tokyo (JP); Yim WONG, Basingstoke (GB); Jimmy CHANG, Sturbridge, MA (US); Man Kit Joe WONG, Kowloon (HK)

(21) Appl. No.: 18/831,446

(22) Filed: Jan. 24, 2025

Related U.S. Application Data
(60) Provisional application No. 63/624,722, filed on Jan. 24, 2024.
(60) Provisional application No. 63/687,549, filed on Aug. 27, 2024.

(51) Int. Cl. G02B 6/38

(52) U.S. Cl. CPC G02B 6/3831; G02B 6/387; G02B 6/3893

(57) ABSTRACT

A fiber optic connector includes a return ramp surface on a connector housing assembly. A remote release member includes a resilient flap that bends outward against the return ramp surface and becomes loaded as a spring when the remote release member is displaced rearward to unlatch the fiber optic connector from a mating receptacle. Subsequently, the resilient flap resiliently rebounds and bears against the return ramp surface to urge the remote release member forward. Another fiber optic connector uses a displaceable remote release member with an integrated resiliently flexible strap that is disposed in relation to the connector housing assembly to flex so that the front end portion of the strap moves downward to depress a depressible adapter latch on the housing assembly. Multifiber ferrules for such connectors can have forward facing shoulders to seat the ferrule in the optical fiber connector.

### CROSS-REFERENCE TO RELATED APPLICATIONS

This application claims priority to U.S. Provisional Patent Application No. 63/624,722, filed Jan. 24, 2024, and U.S. Provisional Patent Application No. 63/687,549, filed Aug. 27, 2024, each of which is hereby incorporated by reference in its entirety.

### FIELD

This disclosure generally fiber optic connectors and multifiber ferrules for fiber optic connectors.

### BACKGROUND

Fiber optic network operators require increased fiber connection density. To meet this demand, the fiber optic industry has developed a new generation of components known as “very, small form factor” (VSFF) components. These components enable innovative fiber optic network designs but are challenging to manufacture due to their small size.

One example of a VSFF product is disclosed in U.S. Pat. No. 12,061,362 (hereinafter, “the '362 patent”). This patent describes a multifiber VSFF connector, which incorporates a small multifiber ferrule in a narrow, upright plug frame with distinct guide rails on the top and bottom. The connector from the '362 patent mates with an adapter, which includes connector ports with upper and lower guide grooves designed to accept the connector's guide rails. The adapter's upper guide grooves include latch recesses at specific positions. The connector of the '362 patent uses a push-pull boot latch mechanism to latch and unlatch with these recesses.

The push-pull boot latch mechanism in the connector of the '362 patent is complex and difficult to manufacture. It consists of a strain relief boot, a spring latch component, and a release arm. The release arm attaches to the strain relief boot and houses the spring latch component. The latter is both geometrically intricate and small. Moreover, the spring latch component serves critical functions, including forming the latch structure that engages the The VSFF platform at issue in the '362 patent is designed to provide higher fiber optic connection density compared to conventional small form factor (SFF) platforms like MPO. Achieving low-loss connections at this density requires significant spring pressure to be applied against the ferrule when the connector is mated to an adapter. The spring latch component is the sole structural element securing the connector in the adapter against the force of the relatively strong ferrule spring.

### SUMMARY

In one aspect, a fiber optic connector comprises a housing assembly having a front end portion and a rear end portion spaced apart along a longitudinal axis. The housing assembly defines a return ramp surface having a front end and a rear end. The return ramp surface is slanted to extend outward with respect to the longitudinal axis as the return ramp surface extends from the front end to the rear end. A fiber optic ferrule for terminating at least one optical fiber is received in the housing assembly. A remote release member is operably coupled to the housing assembly such that the remote release member is movable in relation to the housing assembly from a forward position to a rear position to unlatch the fiber optic connector from a mating adapter. The remote release member includes a resilient flap yieldably biased toward an inward position. The resilient flap is configured to engage the return ramp surface so that, as the remote release member moves from the forward position to the rear position, the return ramp surface drives the resilient flap outward. After being driven outward, the resilient flap is configured to resiliently rebound toward the inward position such that the resilient flap engages the return ramp surface to move the remote release member and the housing assembly relative to one another to return the remote release member to the forward position.

In another aspect, a fiber optic connector comprises a housing assembly having a front end portion and a rear end portion spaced apart along a longitudinal axis. The housing assembly comprises a top wall portion, a bottom wall portion, and a height extending from the top wall portion to the bottom wall portion. The housing assembly further comprises a first side wall portion, a second side wall portion, and a width extending from the first side wall portion to the second side wall portion. The height is greater than the width. The housing assembly includes a depressible adapter latch on the top wall portion. The housing assembly comprises a depressible adapter latch having a front end portion joined to the top wall portion and a depressible portion spaced apart rearward from the front end portion. A multifiber ferrule for terminating a plurality of optical fibers has a fiber alignment axis and is received in the housing assembly so that the fiber alignment axis is parallel to the height of the housing assembly. A push-pull boot member is operably coupled to the housing assembly such that the push-pull boot member is movable in relation to the housing assembly from a forward position to a rear position to unlatch the fiber optic connector from a mating adapter. The push-pull boot member comprises a strain relief boot and an actuator arm extending forward from the strain relief boot. The actuator arm includes a resiliently flexible strap having a front end portion and a rear end portion. The resiliently flexible strap is yieldably biased toward a natural orientation in which the front end portion is at a first level and the rear end portion is at a second level spaced apart below the first level. The resiliently flexible strap is configured to flex so that the front end portion moves downward toward the second level as the push-pull boot member moves from the forward position to the rear position. The front end portion is configured to engage the depressible portion of the depressible adapter latch such that the front end portion depresses the depressible portion as the front end portion moves downward toward the second level.

A multifiber ferrule for an optical fiber connector comprises a ferrule body having a front end and a rear end spaced apart along a longitudinal axis. The ferrule body has a ferrule top, a ferrule bottom, a ferrule height extending from the ferrule top to the ferrule bottom, a first ferrule side, a second ferrule side, and a ferrule width extending from the first ferrule side to the second ferrule side. The ferrule body defines a first longitudinal guide pin passage, a second longitudinal guide pin passage, and a plurality of fiber passages at spaced apart locations along the ferrule height between the first longitudinal guide pin passage and the second longitudinal guide pin passage. The first ferrule side defines a first forward facing shoulder, and the second ferrule side defines a second forward facing shoulder in spaced apart relation with the first ferrule shoulder. The first and second forward facing shoulders are configured to seat the multifiber ferrule in the optical fiber connector.

Other aspects will be in part apparent and in part pointed out hereinafter.

### BRIEF DESCRIPTION OF THE DRAWINGS

FIG. 1 is a perspective of a fiber optic connector in accordance with the present disclosure;

FIG. 2 is a side elevation of the connector;

FIG. 3 is a top plan view of the connector;

FIG. 4 is a front elevation of the connector;

FIG. 5 is an exploded perspective of the connector;

FIG. 6 is a perspective of an adapter for mating with the connector;

FIG. 7 is an end elevation of the adapter;

FIG. 8 is a longitudinal cross section of the adapter;

FIGS. 9A-9K are a series of perspectives illustrating a termination procedure for the connector;

FIG. 10 is a cross-sectional perspective of the connector;

FIG. 11 is an enlarged view of a portion of FIG. 10;

FIG. 12 is a cross section of the connector;

FIG. 13A is a cross section of a subassembly of the connector showing a remote release member thereof in a forward position;

FIG. 13B is a cross section similar to FIG. 13A showing the remote release member at a middle position between the forward position and a rear position;

FIG. 13C is a cross section similar to FIG. 13A showing the remote release member thereof in the rear position;

FIG. 14A is another cross section of a subassembly of the connector showing a remote release member thereof in a forward position;

FIG. 14B is a cross section similar to FIG. 14A showing the remote release member at a middle position between the forward position and a rear position;

FIG. 14C is a cross section similar to FIG. 14A showing the remote release member thereof in the rear position;

FIG. 15 is a perspective of the remote release member;

FIG. 16 is a cross section of the remote release member;

FIG. 17 is another cross section of the connector;

FIG. 18 is an enlarged view of a portion of FIG. 17;

FIG. 19 is a perspective of a multifiber ferrule;

FIG. 20 is another perspective of the multifiber ferrule;

FIG. 21 is a top plan view of the multifiber ferrule;

FIG. 22 is a front elevation of the multifiber ferrule;

FIG. 23 is a perspective of another multifiber ferrule;

FIG. 24 is another perspective of the multifiber ferrule of FIG. 24;

FIG. 25 is a top plan view of the multifiber ferrule of FIG. 24;

FIG. 26 is a front elevation of the multifiber ferrule of FIG. 24;

FIG. 27 is a perspective of another embodiment of a fiber optic connector;

FIG. 28 is a side elevation of the connector of FIG. 27;

FIG. 29 is a front elevation of the connector of FIG. 27;

FIG. 30 is an exploded perspective of the connector of FIG. 27;

FIG. 31 is a perspective showing the connector of FIG. 27 approaching the adapter;

FIG. 32 is a perspective showing the connector of FIG. 27 mated with the adapter;

FIG. 33 is a side elevation of the connector of FIG. 27 mated with the adapter;

FIG. 34 is a cross section of the connector of FIG. 27 mated with the adapter;

FIG. 35 is a cross section similar to FIG. 34 showing the connector of FIG. 27 as it is being pushed into the adapter;

FIG. 36 is a cross section similar to FIG. 34 showing the connector of FIG. 27 as it is being pulled out of the adapter;

FIG. 37 is a perspective showing a second one of the connector of FIG. 27 approaching the adapter from an opposite side of the adapter;

FIG. 38 is an elevation showing two of the connectors of FIG. 27 mated with the adapter;

FIG. 39 is an enlarged fragmentary cross section of a portion of the scene in FIG. 38;

FIG. 40 is another enlarged fragmentary cross section of a portion of the scene in FIG. 38;

FIG. 41 is yet another cross section of a portion of the scene in FIG. 38;

FIG. 42 is a perspective of another embodiment of a fiber optic connector;

FIG. 43 is an exploded perspective of the connector of FIG. 42;

FIG. 44 is an elevation of the connector of FIG. 42;

FIG. 45 is an elevation similar to FIG. 44 showing a remote release member of the connector pulled back;

FIG. 46 is a perspective of another fiber optic connector;

FIG. 47 is an elevation of the connector of FIG. 46;

FIG. 48 is a perspective of another embodiment of a fiber optic connector;

FIG. 49 is an exploded perspective of the connector of FIG. 48;

FIG. 50 is a perspective showing the connector of FIG. 48 approaching a receptacle; and

FIG. 51 is a perspective showing the connector of FIG. 48 mated with the receptacle.

Corresponding parts are given corresponding reference characters throughout the drawings.

### DETAILED DESCRIPTION

In view of the foregoing, the inventors believe that it may be beneficial to provide the market with VSFF fiber optic connectors that do not require the intricate spring latch component used in the connector from the '362 patent. Accordingly, this disclosure provides various VSFF connectors, as well as their VSFF multifiber ferrules, that could be compatible with similar adapters, but which do not require the spring latch component used in the '362 patent. The inventors believe that the connectors described herein could readily be manufactured in the sizes required for VSFF applications and that they would provide robust latching with adapters to withstand the significant spring pressures required for low-loss connections at the intended fiber densities. Although exemplary embodiments of fiber optic connectors in accordance with present disclosure are multifiber connectors, other embodiments include duplex VSFF connectors.

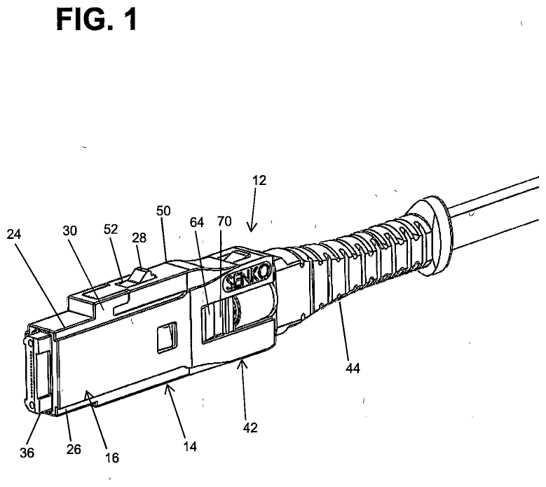

Referring now to FIGS. 1-5, an exemplary embodiment of a fiber optic connector in the scope of the present disclosure is generally indicated at reference number 10. The illustrated fiber optic connector 10 is a multifiber VSFF connector. The connector 10 comprises a push-pull boot latch mechanism 12 that the inventors believe may be more robust and easier to manufacture than the push-pull boot latch mechanism in the connector from the '362 patent.

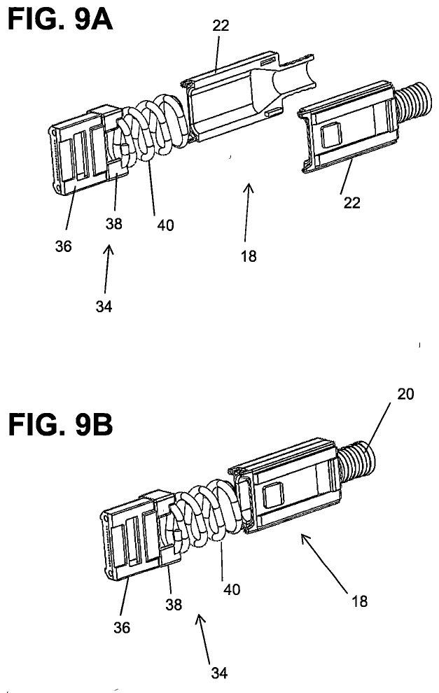

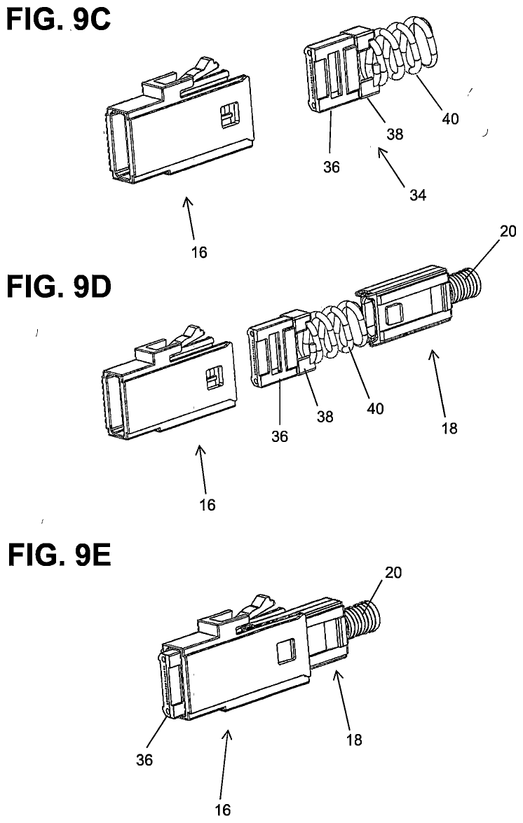

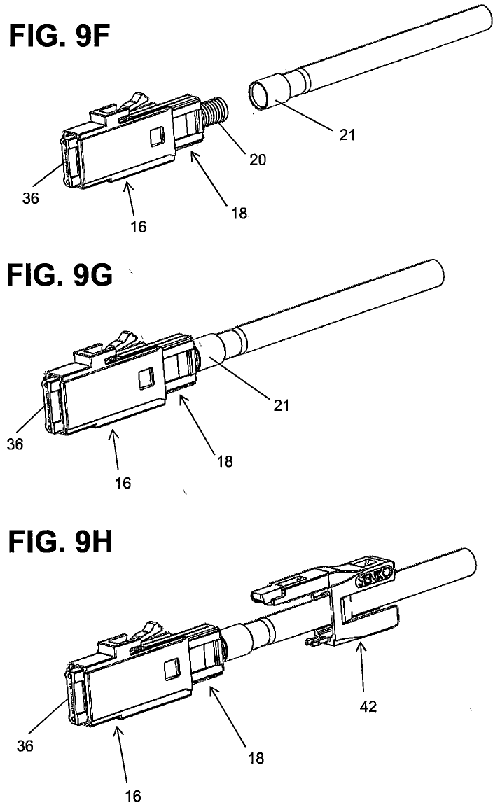

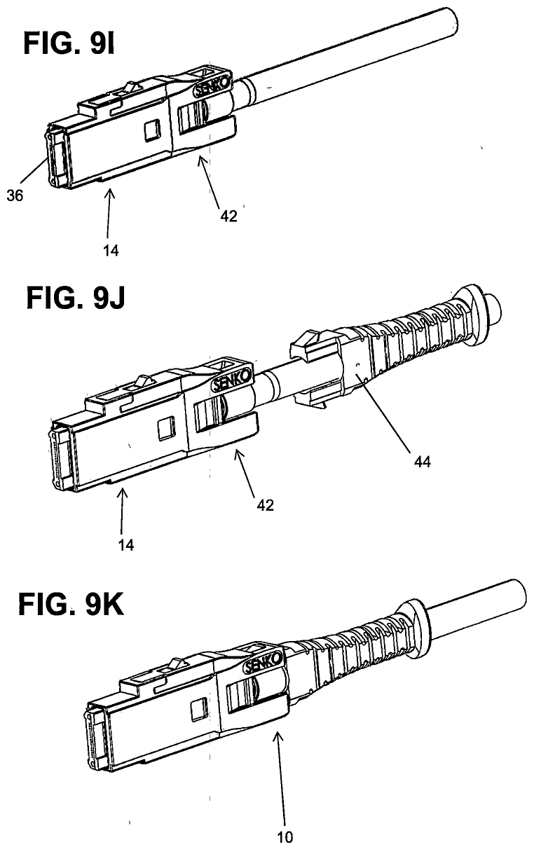

The fiber optic connector 10 comprises a housing assembly 14 made up of a front housing 16 and a back body 18 that defines the connector's back post 20 (FIG. 9E). A crimp ring and heat shrink tube 21 (FIG. 5) can be secured onto the back post 20 to secure an optical fiber cable to the fiber optic connector 10, as will be understood by those skilled in the art. In the illustrated embodiment, the back body 18 is a two-piece back body made up of first and second back body half shells 22 that come together around optical fibers (not shown) to form the back body.

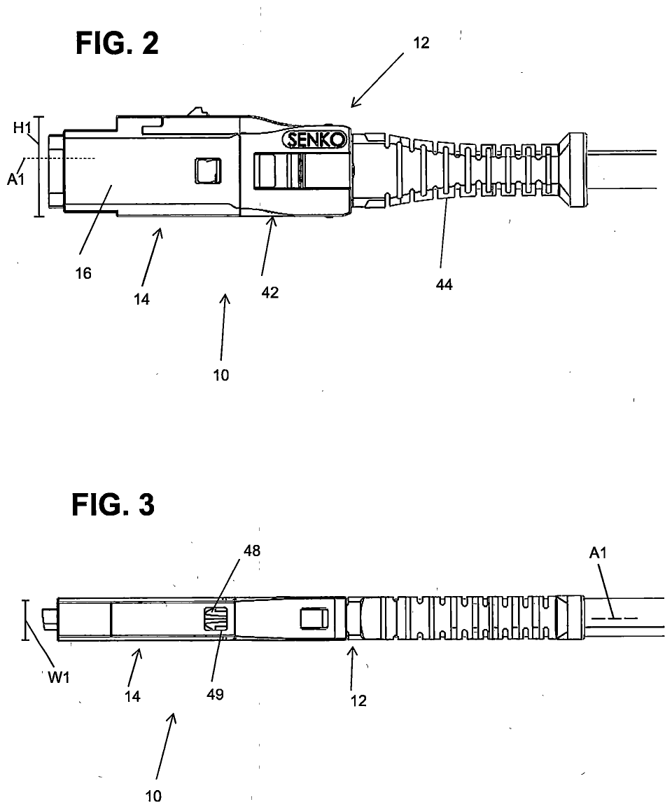

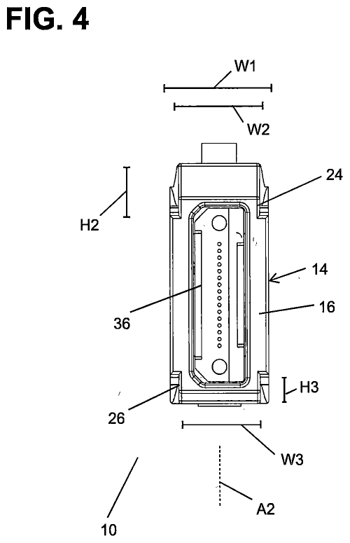

The housing assembly 14 has a front end portion and a rear end portion spaced apart along a longitudinal axis A1. The housing assembly 14 comprises a top wall portion, a bottom wall portion, and a height H1 (FIG. 2) extending from the top wall portion to the bottom wall portion. The housing assembly 14 further comprises a first side wall portion, a second side wall portion, and a width W1 (FIGS. 3 and 4) extending from the first side wall portion to the second side wall portion. The height H1 is greater than the width W1, and hence the housing assembly has a narrow, upright rectangular shape, similar to VSFF connectors that have recently become available.

As shown in FIG. 4, the illustrated housing assembly 14 is shaped and arranged so that the top wall portion comprises an upper rail 24 having an upper rail width W2 and an upper rail height H2 and the bottom wall portion comprises a lower rail 26 having a lower rail width W2 and a lower rail height H3. The lower rail width W3 is less than the upper rail width W2, and the upper rail width is less than the width W1 of the housing assembly 14 overall. The lower rail height H3 is also less than the upper rail height H2.

The front housing 16 (or more broadly, the connector housing assembly 14) comprises an integrated depressible adapter latch 28 (see FIGS. 1 and 5) on the top wall portion. The depressible adapter latch 28 is a simple, integrated latch lever that extends upward and rearward from a front fulcrum where the latch joins the remainder of the front housing 16 to a free rear end portion spaced apart above the top wall portion of the housing assembly.

In addition to the depressible adapter latch 28, the upper wall portion of the illustrated housing assembly 14 (more specifically, the upper wall portion of the front housing 16) comprises a guide fitting 30 in front of the depressible adapter latch. As will be explained in further detail below, the guide fitting is configured to slidably engage a front portion of the push-pull boot latch mechanism 12 to guide movement of the push-pull boot latch mechanism for unlatching the connector 10 from a mating adapter. The guide fitting 30 defines a dovetail groove 32 (FIG. 5) in the illustrated embodiment.

The back body 18 is configured to be secured to the front housing 16 to house a spring-loaded ferrule assembly 34 in the housing assembly 14. As shown in FIG. 5, the spring loaded ferrule assembly 34 comprises a multifiber ferrule 36 (having the approximate size of US Conec's TMT ferrule in the illustrated embodiment) configured for terminating a plurality of optical fibers (not shown), a pin holder 38 configured to retain MT guide pins (not shown) in the multifiber ferrule, and a ferrule spring 40 configured to be loaded between the back body and the pin holder to yieldably bias the multifiber ferrule forward in the housing assembly 14. As shown in FIG. 4, the multifiber ferrule 36 has a fiber alignment axis A2 and is received in the housing assembly 14 so that the fiber alignment axis is parallel to the height H1 of the housing assembly.

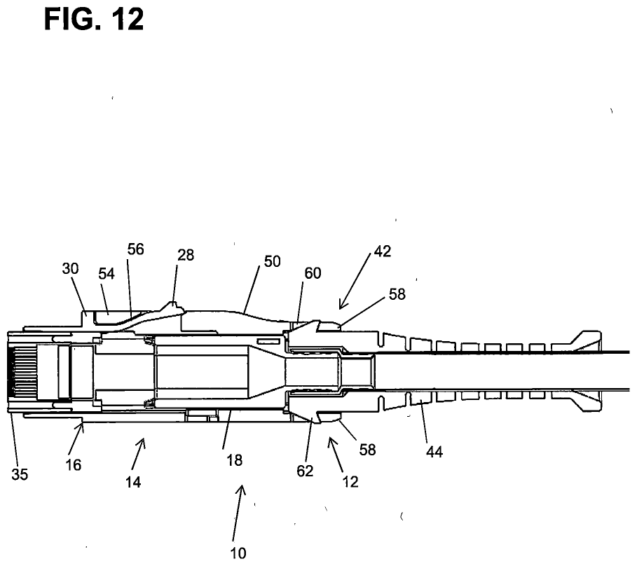

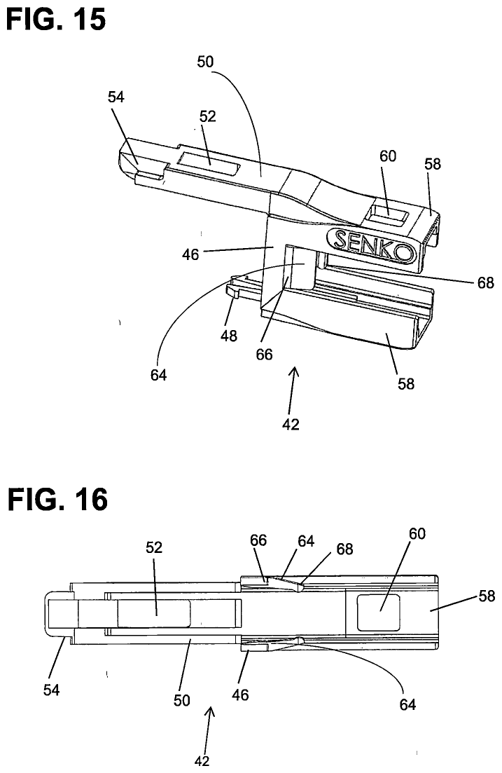

Referring still to FIGS. 1-5, and also to FIGS. 12 and 15-16, the push-pull boot mechanism 12 of the illustrated fiber optic connector 10 comprises a remote release member 42 and a strain relief boot 44. The illustrated remote release member 42 comprises a collar portion 46 (FIG. 15) configured to be disposed around the back body 18. The collar portion 46 comprises top and bottom walls spaced apart heightwise and first and second side walls spaced apart widthwise. Hence, the collar portion 46 is configured to be disposed on the back body 18 so that the top wall is above the back body, the bottom wall is below the back body, and the side walls are on opposite sides of the back body. The collar portion 46 resides rearward of the rear end of the front housing 16 during use. In the illustrated embodiment, the dimensions of the collar portion 46 correspond to the heights H1, H2, H3 and widths W1, W2, W3 of the front housing 14 so that the front housing and the collar portion have a contiguous profile.

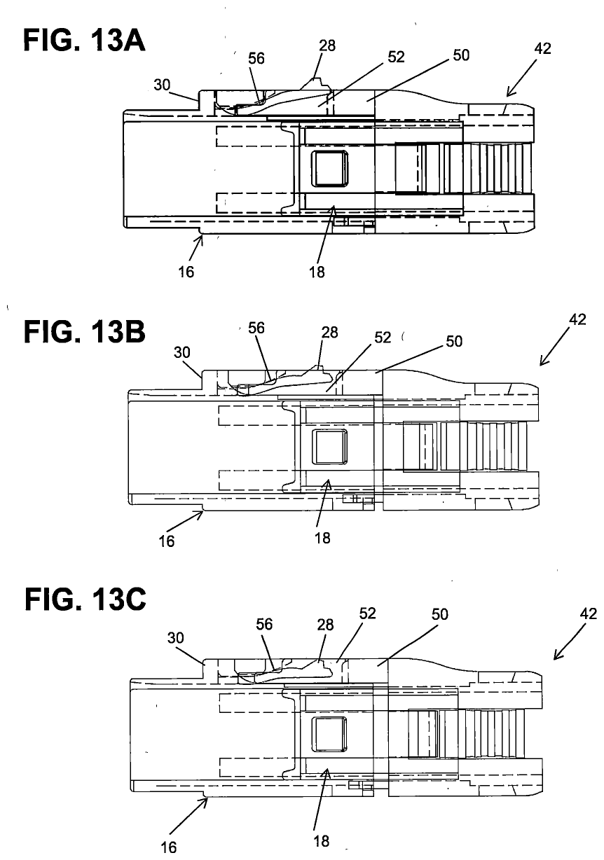

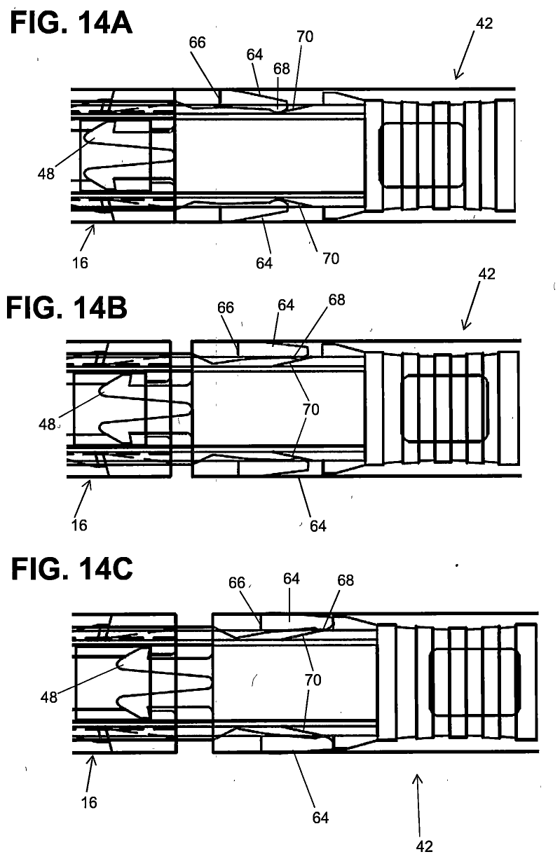

As shown in FIG. 15, the remote release member 42 further comprises retention latches 48 projecting forward from the bottom wall of the collar portion 46. As can be seen in FIG. 3, the retention latches 48 of the remote release member 42 are configured to engage a recess 49 on the bottom wall portion of the front housing 16 to operatively couple the remote release member 42 to the housing assembly 14. The retention latches 48 are configured to engage the front housing 16 in such a way as to allow the remote release member 42 to move longitudinally in relation to the housing assembly 14 in a limited range of motion, but to retain the remote release member on the housing assembly at the rear end of the range of motion. This prevents the remote release member 42 from being pulled off the rear end of the housing assembly 14. FIGS. 13A-13C and FIGS. 14A-15C depict the range of motion of the remote release member 42 in relation to the housing assembly 14. FIGS. 13A and 14A show the remote release member 42 at the forward position, FIGS. 13C and 14C show the remote release at a rear position, and FIGS. 13C and 4C show the remote release member about halfway between the forward and rear positions.

Referring to FIG. 15, the remote release member 42 further comprises an arm 50 extending forward from the top wall of the collar portion 46. The arm 50 comprises a proximal end portion adjacent to the collar portion 46, a distal end portion opposite (longitudinally) the proximal end portion, and an opening 52 spaced apart between the proximal end portion and the distal end portion. The arm 50 is sized and arranged for being slidably received on the top wall portion of the front housing 16. As shown in FIG. 1, when in position, the distal end portion of the arm 50 engages the guide fitting 30, and the opening 52 receives the depressible adapter latch 28. As shown in FIG. 15, the distal end portion of the arm 50 defines a dovetail tongue 54 that is configured to be slidably retained in the dovetail groove 32 of the guide fitting 30. In this way, the guide fitting 30 constrains the arm 50 from moving in relation to the housing assembly 14 either widthwise or heightwise as the remote release member 42 moves longitudinally within the limited range of motion described above.

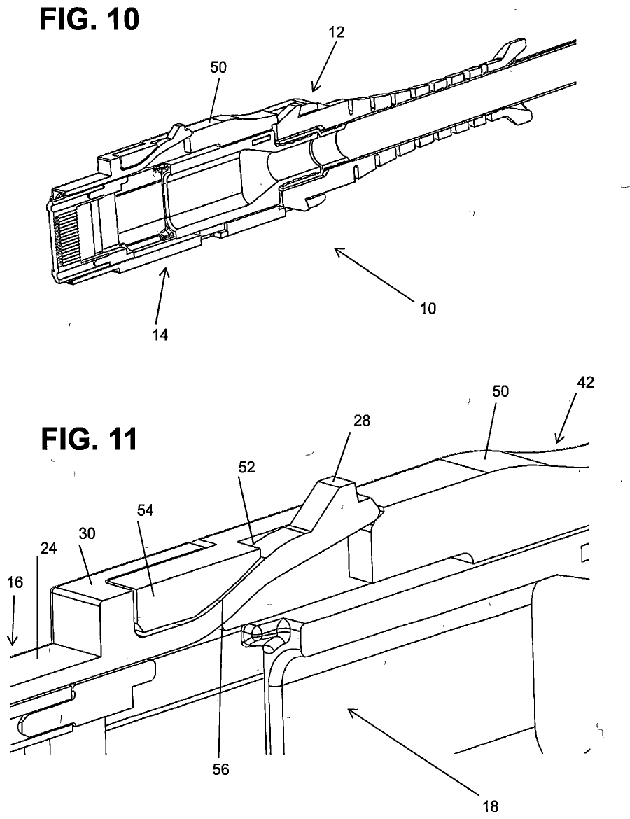

Referring to FIGS. 10 and 11, the arm 50 comprises a rearward facing ramp surface 56 that is configured to oppose the upper surface of the depressible adapter latch 28. During use, when the remote release member 42 moves backward in relation to the housing assembly 14 toward the rear end of its range of motion (see FIGS. 13A-13C), the rearward ramp surface 56 slides along the upper surface of the depressible adapter latch 28 and thereby depresses the adapter latch 28. Thus, the remote release member 42 is movable in relation to the housing assembly 14 from a forward position (FIG. 13A) to a rear position (FIG. 13C) to unlatch the fiber optic connector 10 from a mating adapter.

Referring to FIGS. 12 and 15, the remote release member 42 further comprises upper and lower boot couplings 58 extending rearward from the top and bottom walls of the collar portion 46. Each boot coupling 58 comprises a latch recess 60. The strain relief boot 44 comprises complementary upper and lower boot latches 62 configured to latch with the latch recesses 60 to couple the strain relief boot to the upper and lower boot couplings 58 to attach the strain relief boot to the remote release member 42 so that pulling on the strain relief boot displaces the remote release member along its range of motion from the forward position (FIGS. 13A, 14A) to the rear position (FIGS. 13B, 14B).

Referring to FIGS. 15 and 16, the remote release member 42 further comprises one or more resilient flaps 64 that are configured to function as return springs for yieldably biasing the remote release member 42 (and attached strain relief boot 44) toward the forward position. In the illustrated embodiment, the remote release member 42 comprises first and second resilient flaps on the opposite side walls of the collar portion 46. Each resilient flap 64 is cantilevered from the respective side wall of the collar portion 46. Each resilient flap 64 has a front end joined to the side wall of the collar portion 46 at a resilient living hinge 66. The resilient flaps 64 are rotatable about their respective living hinges but are yieldably biased to an inward position depicted in FIGS. 15 and 16. In the inward position, each resilient flap extends from the respective living hinge 66 rearward and inward widthwise to a rear end portion that defines a cam follower 68. When the remote release member 42 is moved along its range of motion from the forward position to the rear position, the cam follower 68 is configured to follow on an opposing return ramp surface 70 of the housing assembly 14 (described below), which bends the flap outward about the living hinge 66. Whenever the resilient flap 64 bends outward, the resilient properties of the flap urge the flap back inward toward the inward position. The resiliently rebounding flaps 64 impart forces on the housing assembly 14 that urge the remote release member 42 toward the forward position of its range of motion, as will be described in further detail below.

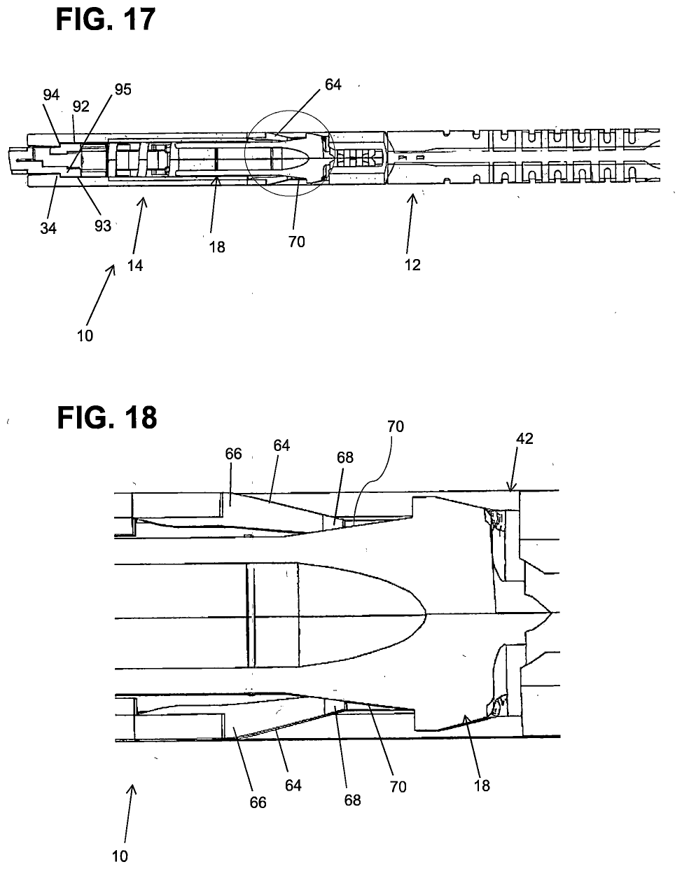

Referring to FIGS. 17 and 18, in the illustrated embodiment, opposite side walls of the back body 18 define return ramp surfaces 70 configured to cammingly bend the resilient flaps 64 outward when the remote release member 42 is displaced rearward in relation to the housing assembly 14. Each return ramp surface 70 has a front end and a rear end spaced apart along the longitudinal axis A1. Each return ramp surface 70 is slanted to extend outward (widthwise) with respect to the longitudinal axis A1 as the return ramp surface extends from the front end to the rear end.

Referring to FIGS. 14A-14C, the engagement of the resilient flaps 64 with the return ramp surfaces 70 along the range of motion of the remote release member 42 is shown in greater detail. The cam follower surfaces 68 rest against the return ramp surfaces 70. FIG. 14A shows the remote release member 42 in the forward position. Here, the resilient flaps 64 are in their natural, inward positions. When the remote release member 42 moves from the forward position to the rear position (FIG. 14C), the return ramp surfaces 70 bends the resilient flaps 64 outward to load the resilient flaps as springs. The outwardly bent resilient flaps 64 tend to rebound about the living hinges 66 toward their natural, inward positions. Hence, the cam followers 68 will bear against the return ramp surfaces 70 to urge the housing assembly 14 backward thereby positioning the remote release member 42 in relation to the housing assembly at its forward position.

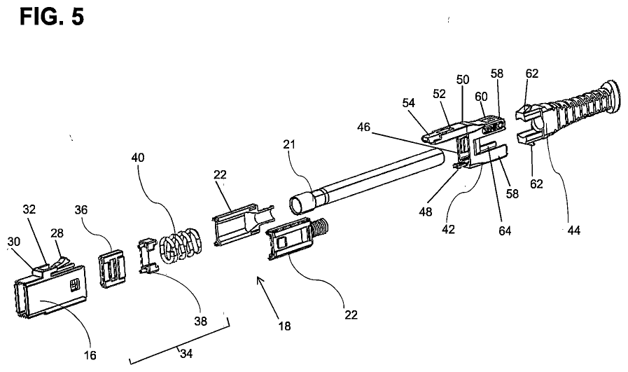

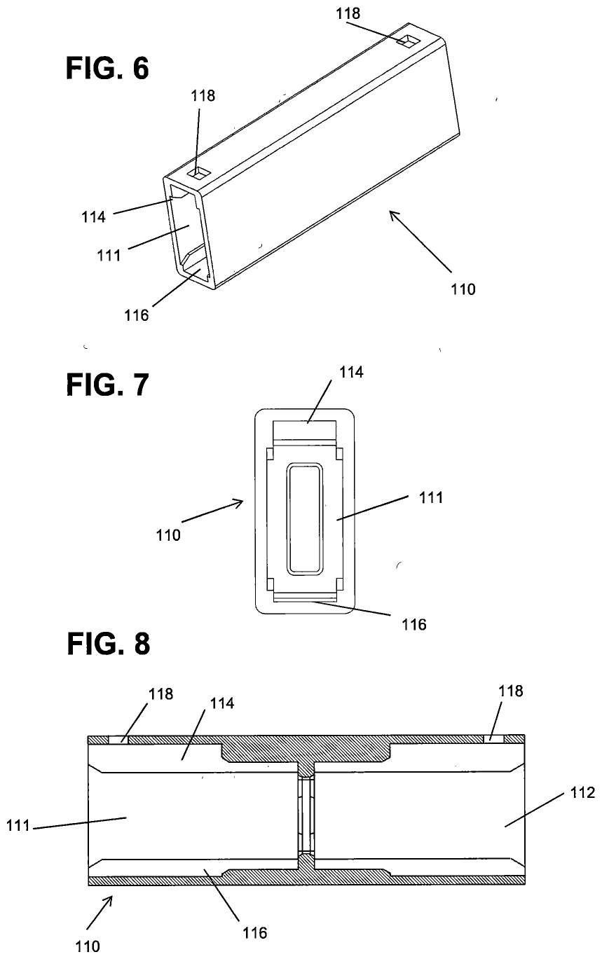

Referring briefly to FIGS. 6-8, a mating adapter for the fiber optic connector 10 is shown at reference number 110. The illustrated adapter 110 is a single-channel adapter, but those skilled in the art will understand that the connector 10 is also configured for mating with multichannel adapters and other types of single-channel or multichannel receptacles (e.g., transceiver receptacles) conforming to the connector's interface specifications. The illustrated adapter 110 comprises opposing first and second ports 111, 112, each configured for mating with one fiber optic connector 10. In each port, 111, 112 the upper wall of the adapter 110 defines an interior upper groove 114 dimensioned to slidably accept the upper rail 24 of the fiber optic connector 10, and the lower wall of the adapter defines an interior lower groove 116 dimensioned to slidably accept the lower rail 26. The upper and lower rails 24, 26 of the connector will only fit into each port 111, 112 in one orientation. The wall structures defining the grooves 114, 116 will interfere with the connector 10 if any attempts are made to insert the fiber optic connector 10 upside down. Along each upper groove 114, the adapter defines a latch recess 118 configured for latching with the depressible adapter latch 28 of the fiber optic connector 10.

During use, the fiber optic connector 10 can be inserted into one of the ports 111, 112 of the adapter 110 by gripping the strain relief boot 44 or the remote release member 42 and pushing the connector forward into the respective port. The pushing forces are transferred from the remote release member 42 to the front housing 16. The upper and lower rails 24, 26 slide into the upper and lower grooves 114, 116. Subsequently, the top of the depressible adapter latch 28 engages the leading edge of the upper wall of the adapter 110, which depresses the depressible adapter latch. The fiber optic connector 10 advances forward until the depressible adapter latch 28 snaps into the latch recess 118, thus mating the fiber optic connector with the adapter 110.

Referring to FIGS. 13A-13C, to remove the fiber optic connector 10 from the adapter 110, the user pulls on the strain relief boot 44. The strain relief boot 44 transfers the pulling forces to the remote release member 42, thereby pulling the remote release member rearward. The housing assembly 14 is initially retained in position with respect to the adapter 110 by the depressible adapter latch 28 being latched with the adapter's latch recess 118. Hence, pulling on the remote release member 42 causes it to move rearward in relation to the housing assembly 14. As the remote release member 42 moves rearward along its range of motion, the guide fitting 30 constrains the arm 50 to move parallel to the longitudinal axis A1. Thus, the arm 50 moves rearward along the longitudinal axis A1 in relation to the housing assembly 14, including the depressible adapter latch 28. During this motion, the ramp surface 56 slides across the upper surface of the depressible adapter latch 28 and drives the adapter latch downward, as shown in FIGS. 13A-13C. This unlatches the fiber optic connector 10 from the mating adapter 110. For example, the free rear end portion of the adapter latch 28 is lowered out of the adapter latch recess 118 into the opening 52.

Simultaneously, as shown in FIGS. 14A-14C, the return ramp surfaces 70 drive the resilient flaps 64 climb along the return ramp surfaces 70 from a first position adjacent the front ends of the return ramp surfaces to a second position adjacent the rear ends of the return ramp surfaces. The return ramp surfaces 70 drive the resilient flaps 64 outward about the living hinges 66, which may be called opening the flaps. Opening or bending the resilient flaps 64 in this way loads the resilient flaps so that they subsequently tend to resiliently rebound back toward their natural, inward positions. In this way, the resilient flaps 64 are loaded to act as return springs. As explained in the preceding paragraph, while this flap opening action is occurring, the connector 10 is simultaneously being unlatched and extracted from the adapter 110. When the fiber optic connector 10 is unmated from the adapter 110, the resilient flaps 64, acting as return springs, resiliently rebound to return the remote release member 42, in relative terms, to the forward position in relation to the housing assembly 14. More specifically, the cam follower surfaces 68 bear against the slanted return ramp surfaces 70 as the resilient flaps 64 rebound, which creates reaction forces between the flaps and the housing assembly 14 that drive the housing assembly and the remote release member 42 toward one another, e.g., returning the remote release member to its forward position in relation to the housing assembly. By automatically returning the remote release member 42 to its forward position, the ramp surface 56 is disengaged from the depressible adapter latch 28, relieving the adapter latch to rebound to its normal raised position, where it protrudes out of the opening 52 above the arm 50.

For completeness, FIGS. 9A-9K depict an example termination procedure for the connector 10. Those skilled in the art will recognize that prior to the termination steps depicted in FIGS. 9A-9K, various connector components (e.g., the ferrule spring 40, the crimp ring and heat shrink tube 21, the remote release member 42, and the strain relief boot 44) would be threaded over an optical fiber cable (not shown) and optical fibers from the cable would be terminated in the multifiber ferrule 36. In FIG. 9A, the pin holder 38 and ferrule spring 40 are positioned behind the multifiber ferrule 36. The back body half shells 22 are then secured together around the optical fibers (not shown) to form the back body 18, as depicted in FIG. 9B. As shown in FIGS. 9C-9E, the spring-loaded ferrule assembly 34 is placed into the front housing 16, and the back body 18 is installed in the rear end portion of the front housing to load the ferrule spring 40. As shown in FIGS. 9F and 9G, the crimp ring and heat shrink tube 21 are then installed on the back post 20 and cable (not shown). As shown in FIGS. 9H and 9I, next, the remote release member 42 is brought forward on the cable and installed on the housing assembly 14. Last, as shown in FIGS. 9J and 9K, the strain relief boot 44 is brought forward and secured to the remote release member 42.

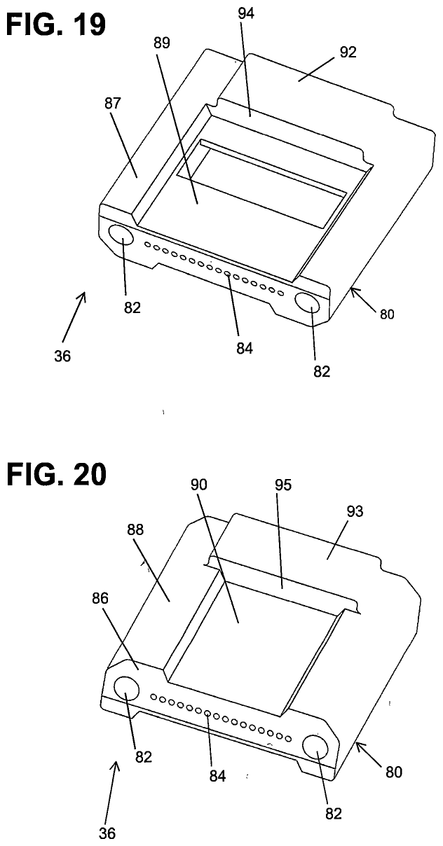

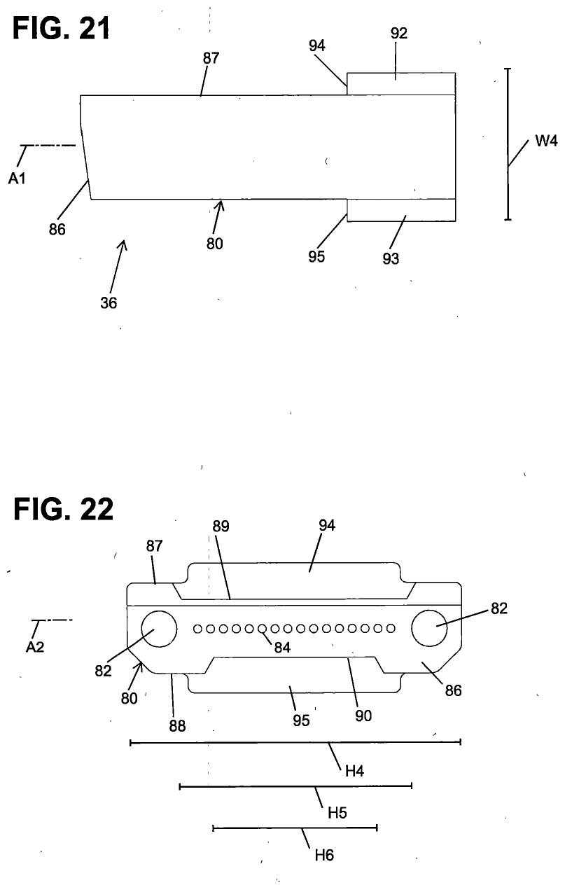

Referring now to FIGS. 19-22, an exemplary embodiment of the multifiber ferrule 36 is shown in greater detail. The multifiber ferrule 36 comprises a ferrule body 80 having a front end and a rear end spaced apart along the longitudinal axis A1. The ferrule body 80 is formed from a single monolithic piece of material. The ferrule body 80 has a ferrule top, a ferrule bottom, a ferrule height H4 extending from the ferrule top to the ferrule bottom, a first ferrule side, a second ferrule side, and a ferrule width W4 extending from the first ferrule side to the second ferrule side. The ferrule body 80 defines first and second longitudinal guide pin passages 82 and a plurality of fiber passages 84 at spaced apart locations along the ferrule height H4 between the first longitudinal guide pin passage and the second longitudinal guide pin passage. In the illustrated embodiment, the guide pin passages 82 and fiber passages 84 are arranged in a single-file row along the fiber alignment axis A2. Suitably, the ferrule 36 can define an angled contact face 86 at the front end of the ferrule body 80.

In the illustrated embodiment, the first and second ferrule sides have major planar surfaces 87, 88 and recesses 89, 90 inset from the major surfaces. The recesses 89, 90 are centrally located along the ferrule height H4 and have heights H5, H6 less than the ferrule height H4. In the illustrated embodiment, the recesses 88, 90 have different heights H5, H6. Those skilled in the art will recognize that similar recesses are used in the TMT ferrule for keying the ferrule in relation to the housing assembly.

Behind the recesses 89, 90, the first and second ferrule sides of the illustrated ferrule body 80 form projections 92, 93, defining forward facing shoulders 94, 95 configured for seating the multifiber ferrule 36 in the connector housing assembly 14 as shown in FIG. 17. The forward facing shoulders 94, 95 are located outboard of the major surfaces 87, 88 of the first and second ferrule sides.

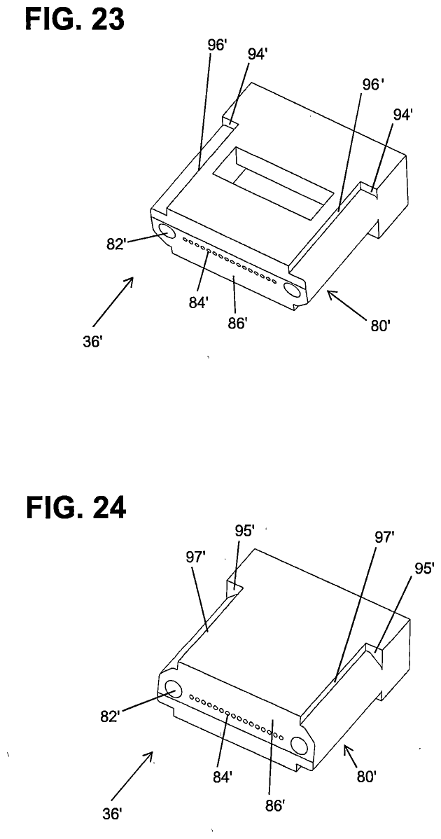

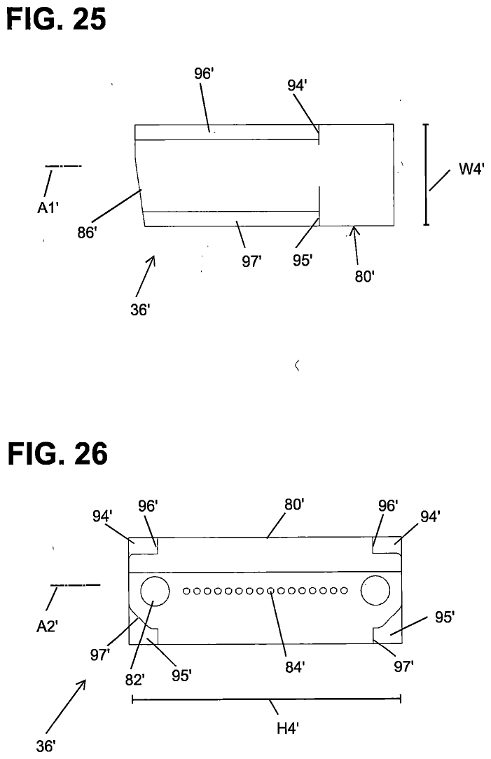

Referring now to FIGS. 23-26, another exemplary embodiment of a multifiber ferrule 36′ is shown in detail. The multifiber ferrule 36′ is similar to the multifiber ferrule 36, and corresponding parts and dimensions are given the same reference number followed by a prime symbol.

The multifiber ferrule 36′ comprises a ferrule body 80′ having a front end and a rear end spaced apart along a longitudinal axis A1′. The ferrule body 80′ is formed from a single monolithic piece of material. The ferrule body 80′ has a ferrule top, a ferrule bottom, a ferrule height H4′ extending from the ferrule top to the ferrule bottom, a first ferrule side, a second ferrule side, and a ferrule width W4′ extending from the first ferrule side to the second ferrule side. The ferrule body 80′ defines first and second longitudinal guide pin passages 82′ and a plurality of fiber passages 84′ at spaced apart locations along the ferrule height H4′ between the first longitudinal guide pin passage and the second longitudinal guide pin passage. In the illustrated embodiment, the guide pin passages 82′ and fiber passages 84′ are arranged in a single-file row along the fiber alignment axis A2′. Suitably, the ferrule 36 can define an angled contact face 86′ at the front end of the ferrule body 80.

The illustrated ferrule lacks central recesses in the first and second ferrule sides. The first and second ferrule sides have major planar surfaces 87′, 88′, and notches 96′, 97′ along each corner where the respective ferrule side meets the ferrule top or ferrule bottom. The notches 96′, 97′ open through the front ferrule end, but the rear ends of the notches 96′, 97′ are enclosed by forward facing shoulders 94′, 95′ of the one-piece ferrule body. The forward facing shoulders 94′, 95′ are configured for seating the multifiber ferrule 36′ in a complementary connector housing assembly (not shown).

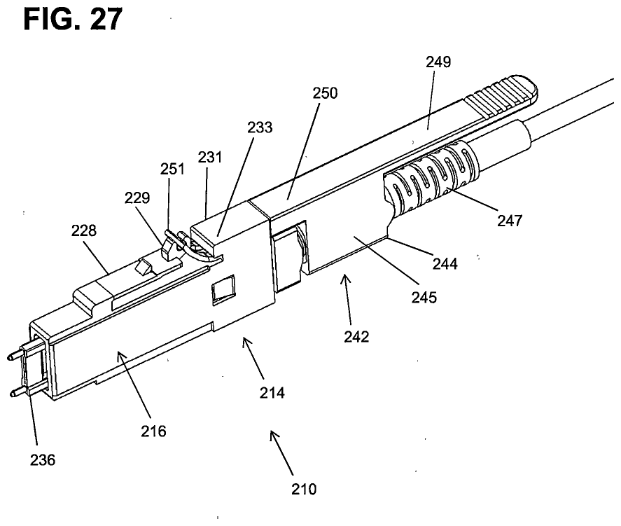

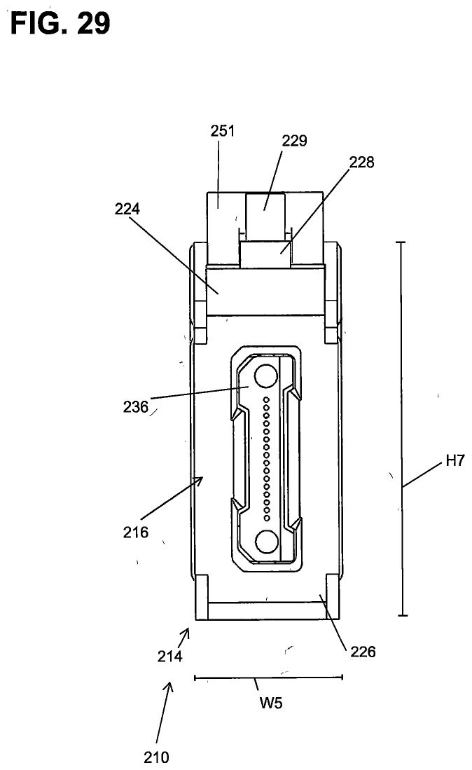

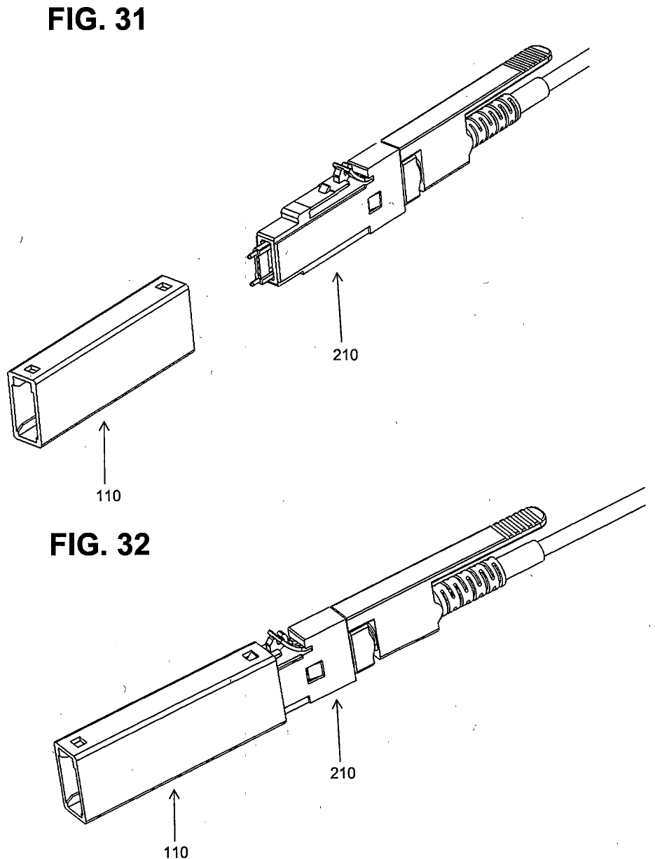

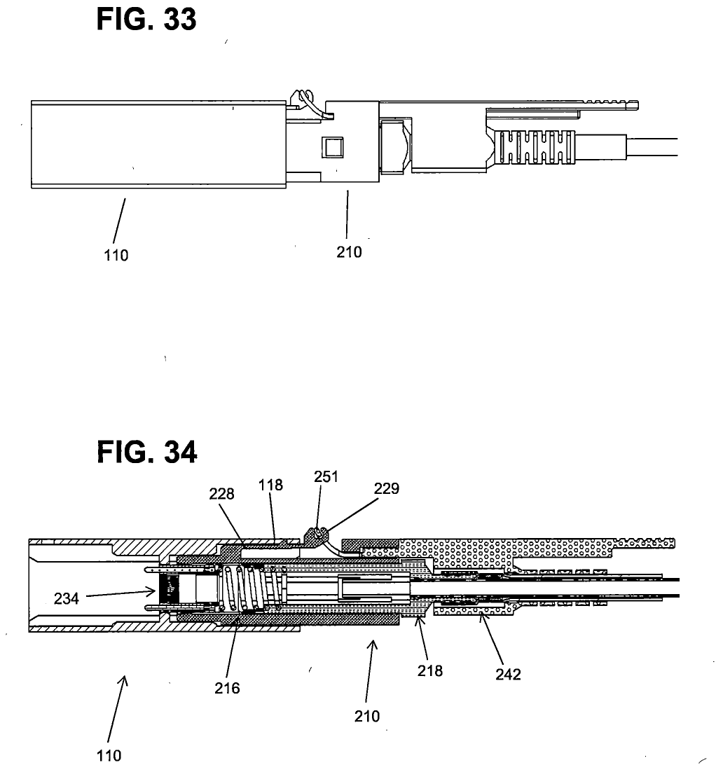

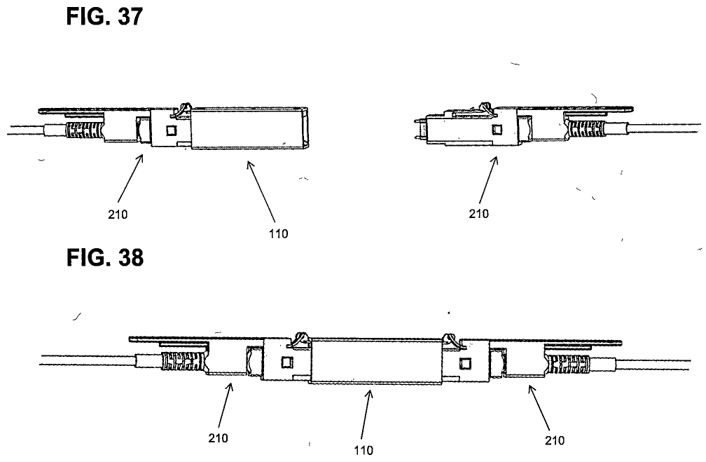

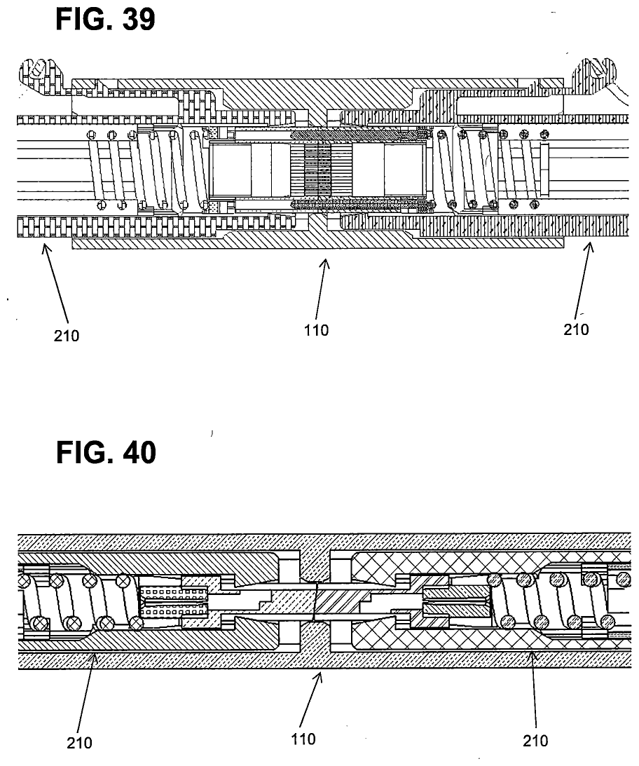

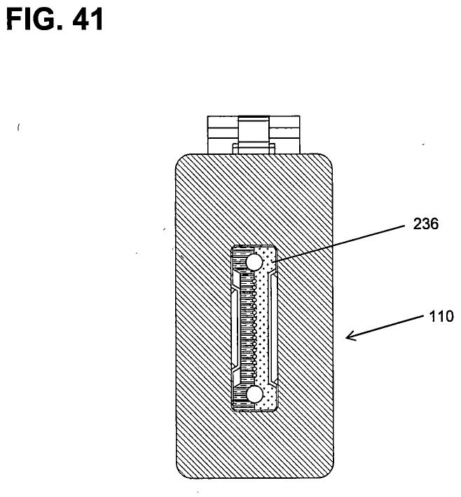

Referring now to FIGS. 27-41 another embodiment of a fiber optic connector in accordance with the present disclosure is generally indicated at reference number 210. Like the fiber optic connector 10 described above, the fiber optic connector 210 is mateable with the adapter 110. However, it will be understood that features of the connector 210 can be used with connectors for other fiber optic platforms without departing from the scope of the disclosure. Because the fiber optic connector 210 has similarities to the fiber optic connector 10 described above, features of the former that correspond with features of the latter will be given the same reference number, plus 200.

The fiber optic connector 210 comprises a housing assembly 214 made up of a front housing 216 and a back body 218 that defines the connector's back post 220. A crimp ring and heat shrink tube 221 can be secured onto the back post 220 to mechanically connect an optical fiber cable to the fiber optic connector 210. In the illustrated embodiment, the back body 218 is a one-piece back body.

The housing assembly 214 has a front end portion and a rear end portion spaced apart along a longitudinal axis A3. The housing assembly 214 comprises a top wall portion, a bottom wall portion, and a height H7 extending from the top wall portion to the bottom wall portion. The housing assembly 14 further comprises a first side wall portion, a second side wall portion, and a width W5 extending from the first side wall portion to the second side wall portion. The height H7 is greater than the width W5, and hence the housing assembly has a narrow, upright rectangular shape. Consistent with the available VSFF platforms, the illustrated housing assembly 214 is shaped and arranged so that the top wall portion comprises an upper rail 224 and lower rail 226 dimensioned like the upper rail 24 and lower rail 26 of the housing assembly 14 of the fiber optic connector 10.

The front housing 216 (or more broadly, the connector housing assembly 214) comprises an integrated depressible adapter latch 228 on the top wall portion. The depressible adapter latch 228 is a simple, integrated latch lever that extends rearward from a front fulcrum where the latch joins the remainder of the front housing 216 to a free rear end portion spaced apart above the top wall portion of the housing assembly. The rear end portion of the depressible adapter latch 228 defines a hook 229 configured to operatively connect the depressible adapter latch to a remote release mechanism of the fiber optic connector 210 as will be described in further detail below.

In addition to the depressible adapter latch 228, the upper wall portion of the illustrated housing assembly 214 comprises a guide bridge 231 comprising an upper portion 233. The guide bridge 231 defines a strap slot 235 between the upper portion 233 and the top wall portion of the housing assembly 214.

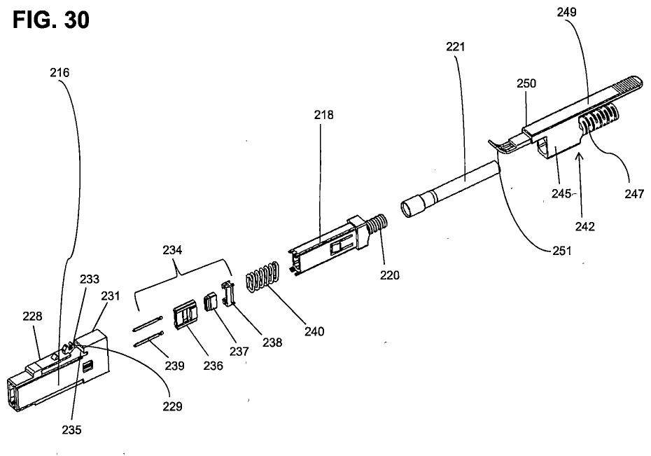

The back body 218 is configured to be secured to the front housing 216 to contain a spring-loaded ferrule assembly 234 in the housing assembly 214. As shown in FIG. 30, the spring loaded ferrule assembly 234 comprises a multifiber ferrule 236 (having the approximate size of US Conec's TMT ferrule in the illustrated embodiment) configured for terminating a plurality of optical fibers (not shown), a ferrule boot 237, a pin holder 238 configured to retain MT guide pins 239 in the multifiber ferrule, and a ferrule spring 240 configured to be loaded between the back body and the pin holder to yieldably bias the multifiber ferrule forward in the housing assembly 214.

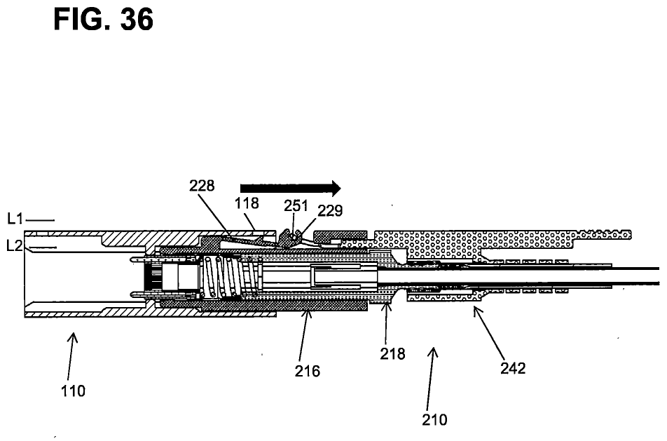

The fiber optic connector 210 further comprises a push-pull boot member 242 (broadly, a remote release member) operably coupled to the housing assembly 214 such that the push-pull boot member is movable in relation to the housing assembly from a forward position (FIG. 34) to a rear position (FIG. 36) to unlatch the fiber optic connector from a mating adapter 110. The push-pull boot member 242 comprises a strain relief boot 244 and an actuator arm 250 extending forward from the strain relief boot. The strain relief boot 244 comprises a main body 245 and a flexible slotted tube 247 extending rearward from the main body. The push-pull boot member 242 further comprises a push-pull tab 249 rearwardly cantilevered from the main body and spaced apart above the flexible slotted tube 247 of the strain relief boot 244.

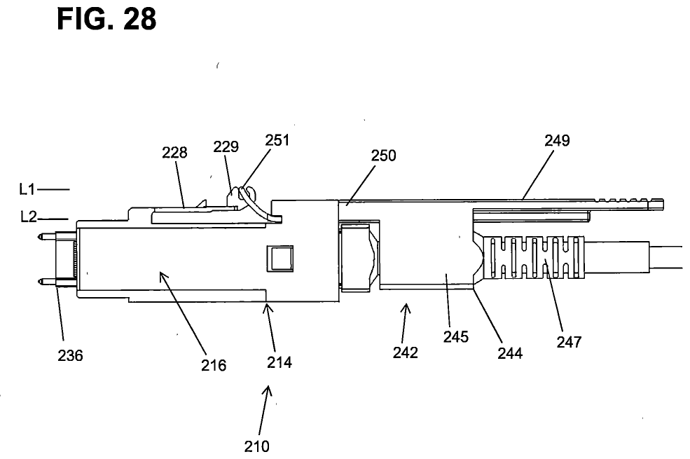

The actuator arm 250 includes a resiliently flexible strap 251 having a front end portion and a rear end portion. In the illustrated embodiment, the flexible strap 251 forms a loop looping around the rear end portion of the depressible adapter latch 228 such that the front end portion of the strap is received in the hook 229. The resiliently flexible strap 251 is yieldably biased toward a natural orientation, shown in all drawings accept for FIG. 36. As shown in FIG. 28, in the natural orientation, the front end portion of the resiliently flexible strap 251 is at a first level L1 and the rear end portion is at a second level L2 spaced apart below the first level heightwise. As can be seen in FIG. 36, the resiliently flexible strap 251 is configured to flex so that the front end portion moves downward toward the second level L2 as the push-pull boot member 242 moves from the forward position to the rear position. The front end portion of the resiliently flexible strap 251 is configured to engage the rear end portion of the depressible adapter latch 228 (e.g., by reception in the hook 229) such that the front end portion depresses the depressible adapter latch as the front end portion moves downward toward the second level L2.

The flexible strap 251 is slidably received in the strap slot 235 of the guide bridge 231. The upper portion 233 of the guide bridge 231 is configured to bear against the flexible strap 251 and drive the front end portion downward toward the second level L2 as the push-pull boot member moves from the forward position to the rear position.

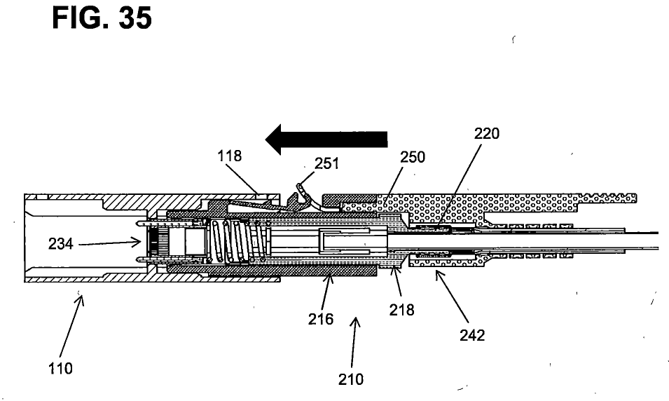

Referring to FIG. 35, during use, the fiber optic connector 210 can be inserted into the adapter 110 by gripping the push-pull boot member 242 and pushing the connector forward into a port. The pushing forces are transferred from the push-pull boot member 242 to the front housing 216. A protruding catch on top of the depressible adapter latch 228 engages the leading edge of the upper wall of the adapter 110, which depresses the depressible adapter latch downward. The fiber optic connector 210 advances forward until the depressible adapter latch 228 snaps into the latch recess 118, thus mating the fiber optic connector with the adapter 110.

As shown in FIG. 36, to remove the fiber optic connector 210 from the adapter 110, the user pulls on the push-pull boot member 242. The housing assembly 214 is initially retained in position with respect to the adapter 110 by the depressible adapter latch 228 being latched with the adapter's latch recess 118. Hence, pulling on the push-pull boot member 242 causes the push-pull boot member 242 to move rearward in relation to the housing assembly 214. As the push-pull boot member 242 moves rearward, the resiliently flexible strap 251 slides rearward in the strap slot 235. The upper portion 233 of the guide bridge 213 bears against the top of the resiliently flexible strap 251 as it slides, driving the resiliently flexible strap downward, and in turn, driving the depressible adapter latch 228 downward to unlatch the connector 210 from the adapter 110. Further pulling on the push-pull boot extracts the fiber optic connector 210 from the adapter 110.

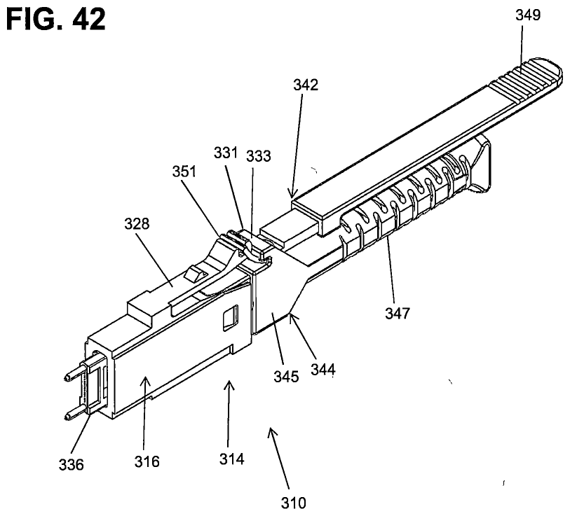

Referring to FIGS. 42-45 another embodiment of a fiber optic connector in accordance with the present disclosure is generally indicated at reference number 310. Like the fiber optic connectors 10 and 210 described above, the fiber optic connector 310 is configured to mate with the adapter 110. However, it will be understood that features of the connector 310 can be used with connectors for other fiber optic platforms without departing from the scope of the disclosure. Because the fiber optic connector 310 has similarities to the fiber optic connector 210 described above, features of the former that correspond with features of the latter will be given the same reference number, plus 100.

The fiber optic connector 310 comprises a housing assembly 314 made up of a front housing 316 and a back body 318 that defines the connector's back post 320. A crimp ring and heat shrink tube 321 can be secured onto the back post 320 to mechanically connect an optical fiber cable to the fiber optic connector 310. In the illustrated embodiment, the back body 318 is a one-piece back body. The housing assembly 314 suitably has the same perimeter dimensions as the housing assembly 214 so that the fiber optic connector 310 can mate with the same adapter 110 as the fiber optic connector 210.

The front housing 316 (or more broadly, the connector housing assembly 214) comprises an integrated depressible adapter latch 328 on the top wall portion. The depressible adapter latch 328 is a simple, integrated latch lever that extends rearward from a front fulcrum where the latch joins the remainder of the front housing 316 to a free rear end portion spaced apart above the top wall portion of the housing assembly 314. The rear end portion of the depressible adapter latch 328 defines a hook 329 configured to operatively connect the depressible adapter latch to a remote release mechanism of the fiber optic connector 310, as will be described in further detail below.

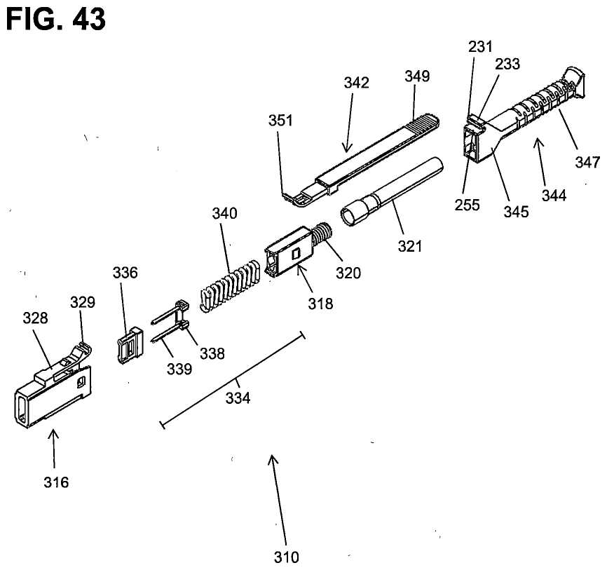

The back body 318 is configured to be secured to the front housing 316 to contain a spring-loaded ferrule assembly 334 in the housing assembly 314. As shown in FIG. 43, the spring loaded ferrule assembly 334 comprises a multifiber ferrule 336 (having the approximate size of US Conec's TMT ferrule in the illustrated embodiment) configured for terminating a plurality of optical fibers (not shown), a pin holder 338 configured to retain MT guide pins 339 in the multifiber ferrule, and a ferrule spring 340 configured to be loaded between the back body 318 and the pin holder to yieldably bias the multifiber ferrule forward in the housing assembly 314.

The fiber optic connector 310 further comprises a stationary strain relief boot 344. The strain relief boot 344 comprises a main body 345 and a flexible slotted tube 347 extending rearward from the main body. A guide bridge 331 is formed atop the main body 345 of the strain relief boot 344. The guide bridge 331 defines a strap slot 335 between an upper portion 333 and the main body 345 of the strain relief boot 344.

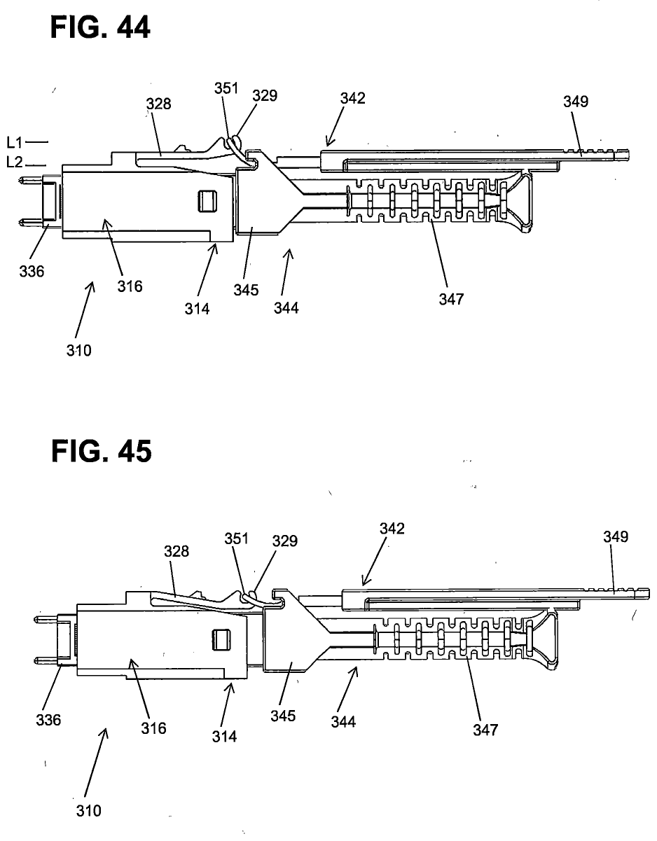

The fiber optic connector 310 further comprises a remote release member 342 comprising a pull tab 349 at a rear end and a resiliently flexible strap 351 at a front end. In general, the remote release member 342 is configured so that a user can pull rearward on the pull tab 349 to unlatch the fiber optic connector 310 from a mating adapter 110. The flexible strap 351 forms a loop looping around the rear end portion of the depressible adapter latch 328 such that the front end portion of the strap is received in the hook 329. The resiliently flexible strap 351 is yieldably biased toward a natural orientation, shown in all drawings accept for FIG. 45. As shown in FIG. 44, in the natural orientation, the front end portion of the resiliently flexible strap 351 is at a first level L1 and the rear end portion is at a second level L2 spaced apart below the first level heightwise. As can be seen in FIG. 45, the resiliently flexible strap 351 is configured to flex so that the front end portion moves downward toward the second level L2 as the remote release member 342 moves from the forward position to the rear position. The front end portion of the resiliently flexible strap 351 is configured to engage the rear end portion of the depressible adapter latch 328 (e.g., by reception in the hook 329) such that the front end portion depresses the depressible adapter latch as the front end portion moves downward toward the second level L2.

The flexible strap 351 is slidably received in the strap slot 335 of the guide bridge 331. The upper portion 333 of the guide bridge 331 is configured to bear against the flexible strap 351 and drive the front end portion downward toward the second level L2 as the push-pull remote release member 342 moves from the forward position to the rear position.

During use, the fiber optic connector 310 can be inserted into the adapter 110 by gripping the strain relief boot 244 and pushing the connector forward into a port. To remove the fiber optic connector 310 from the adapter 110, the user pulls on the push-pull tab 349. The housing assembly 314 is initially retained in position with respect to the adapter 110 by the depressible adapter latch 328 being latched with the adapter's latch recess 118. Hence, pulling on the push-pull tab 349 causes the remote release member 342 to move rearward in relation to the housing assembly 314. As the remote release member 342 moves rearward, the resiliently flexible strap 351 slides rearward in the strap slot 335. The upper portion 333 of the guide bridge 313 bears against the top of the resiliently flexible strap 351 as it slides, driving the resiliently flexible strap downward, and in turn, driving the depressible adapter latch 328 downward to unlatch the connector 310 from the adapter 110. Further pulling on the push-pull boot extracts the fiber optic connector 310 from the adapter 110.

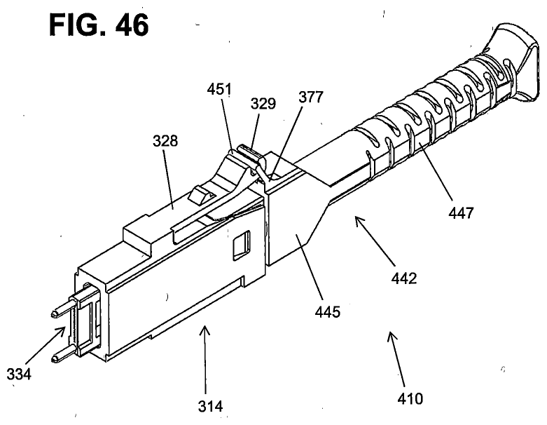

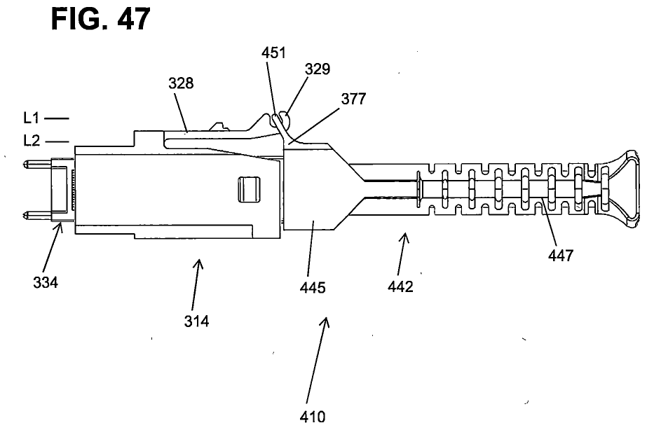

Referring to FIGS. 46 and 47, yet another embodiment of a fiber optic connector in accordance with the present disclosure is generally indicated at reference number 410. Like the fiber optic connectors 10, 210, and 310 described above, the fiber optic connector 410 is configured to mate with the adapter 110. However, it will be understood that features of the connector 410 can be used with connectors for other fiber optic platforms without departing from the scope of the disclosure. The fiber optic connector 410 uses the housing assembly 314 and spring-loaded ferrule assembly 334 from the connector 310 but a different remote release mechanism. In particular, the connector 410 uses a push-pull boot member 442 (broadly, a remote release member) with an integrated resiliently flexible strap 451. The push-pull boot member 442 is configured to be displaced rearward in relation to the housing assembly 314, which causes the resiliently flexible strap 451 to flex and depress the depressible adapter latch 328. The illustrated resiliently flexible strap 451 is configured to flex without a guide to press the strap downward.

The push-pull boot member 442 comprises a main body 445 and a slotted flexible tube 447, and the resiliently flexible strap 451 extends forward and upward from the main body 445. The resiliently flexible strap 451 forms a loop looping around the rear end portion of the depressible adapter latch 328 such that the front end portion of the strap is received in the hook 329. The resiliently flexible strap 451 is yieldably biased toward a natural orientation, shown in the drawings. In the natural orientation, the front end portion of the resiliently flexible strap 451 is at a first level L1 and the rear end portion is at a second level L2 spaced apart below the first level heightwise. When the push-pull boot member 442 is displaced rearward, the resiliently flexible strap 451 flexes by bending downward about a fulcrum 377 at its rear end. Thus, the front end moves downward toward the second level L2 as the push-pull boot member 442 moves from its forward position to its rear position. The front end portion of the resiliently flexible strap 451 is configured to engage the rear end portion of the depressible adapter latch 328 (e.g., by reception in the hook 329) such that the front end portion depresses the depressible adapter latch as the front end portion moves downward toward the second level L2.

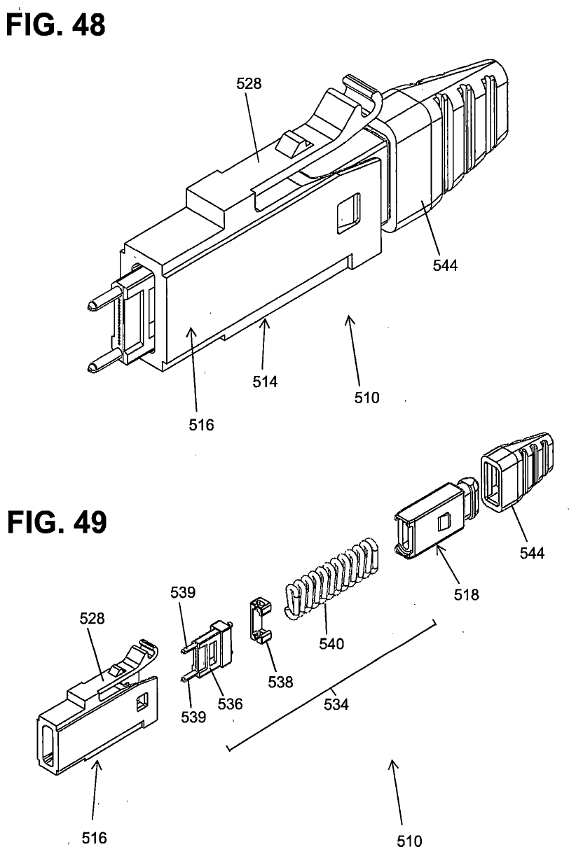

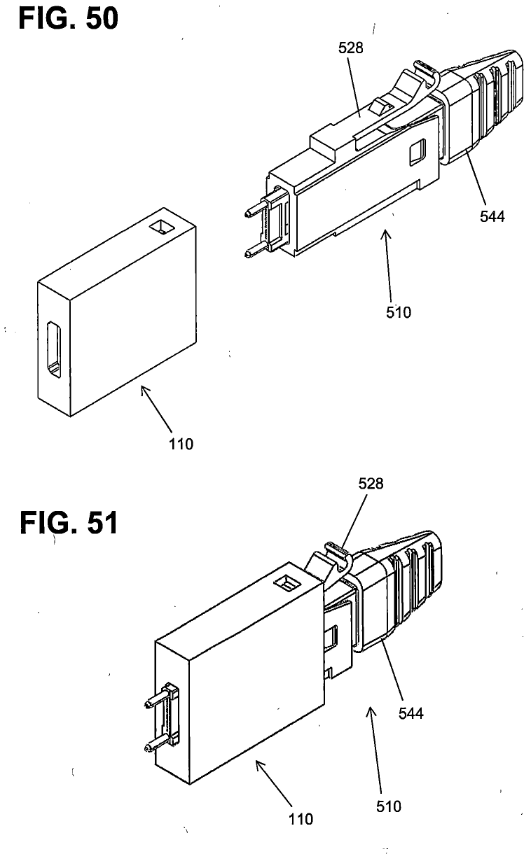

Referring to FIGS. 48-51, another embodiment of a fiber optic connector in accordance with the present disclosure is generally indicated at reference number 510. The connector 510 is still another connector configured to mate with the adapter 110, but unlike the proceeding connectors 10, 210, 310, 410; the connector 510 lacks a push-pull latch mechanism. Instead it comprises a housing assembly 514 with an integrated adapter latch 528 configured so that the rear end portion is accessible when the connector 510 is mated with a receptacle 110′ (FIG. 51). This allows a user to depress the latch 528 directly to unlatch the connector 510 from the mating receptacle 110′. The connector 510 may be useful for behind-the-wall applications or applications that where unjacketed fiber optic cables are preferred.

The housing assembly 514 comprises of a front housing 516 and a one-piece back body 518. The housing assembly 514 suitably has the same perimeter dimensions as the housing assemblies 14, 214, 314, 414 so that the fiber optic connector 510 can mate with the same adapter 110 as the fiber optic connectors 10, 210, 310, and 410. Hence, it will be understood that the receptacle 110′ depicted in FIGS. 50 and 51 has the same interface geometry as the adapter 110 described above. The back body 518 is configured to be secured to the front housing 516 to contain a spring-loaded ferrule assembly 534 in the housing assembly 514. As shown in FIG. 49, the spring loaded ferrule assembly 534 comprises a multifiber ferrule 536 configured for terminating a plurality of optical fibers (not shown), a pin holder 538 configured to retain MT guide pins 539 in the multifiber ferrule, and a ferrule spring 540 configured to be loaded between the back body 518 and the pin holder to yieldably bias the multifiber ferrule forward in the housing assembly 514. The fiber optic connector 310 further comprises a stationary strain relief boot 544 that secures to the rear end portion of the back body 518. The illustrated strain relief boot 522 is truncated and less round than the strain relief boots of the previous embodiments.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A fiber optic connector comprising:
a housing assembly having a front end portion and a rear end portion spaced apart along a longitudinal axis, the housing assembly defining a return ramp surface having a front end and a rear end, the return ramp surface extending outward with respect to the longitudinal axis as the return ramp surface extends from the front end to the rear end;
a fiber optic ferrule for terminating at least one optical fiber received in the housing assembly;
a remote release member operably coupled to the housing assembly such that the remote release member is movable in relation to the housing assembly from a forward position to a rear position to unlatch the fiber optic connector from a mating adapter, the remote release member including a resilient flap yieldably biased toward an inward position, the resilient flap being configured to engage the return ramp surface so that, as the remote release member moves from the forward position to the rear position, the return ramp surface drives the resilient flap outward,
wherein after being driven outward, the resilient flap is configured to resiliently rebound toward the inward position such that the resilient flap engages the return ramp surface to move the remote release member and the housing assembly relative to one another to return the remote release member to the forward position.

2. The fiber optic connector of claim 1, wherein the housing assembly comprises a front housing and a back body defining a back post, the back body defining the return ramp surface.

3. The fiber optic connector of claim 2, wherein the remote release member comprises a collar portion disposed around the back body, the resilient flap being located on the collar portion.

4. The fiber optic connector of claim 3, wherein the return ramp surface comprises first and second return ramp surfaces on opposite sides of the back body and wherein the resilient flap comprises first and second resilient flaps on opposite sides of the collar portion.

5. The fiber optic connector of claim 3, wherein the remote release member further comprises an arm extending forward from the collar portion, the arm being slidably engaged with the front housing.

6. The fiber optic connector of claim 5, wherein the front housing comprises a depressible adapter latch, the arm being operatively coupled to the depressible adapter latch such that the arm depresses the adapter latch when the remote release member is displaced from the forward position to the rear position.

7. The fiber optic connector of claim 6, wherein the arm comprises a proximal end portion adjacent to the collar portion, a distal end portion opposite the proximal end portion, and an opening spaced apart between the proximal end portion and the distal end portion, the depressible adapter latch being received in the opening.

8. The fiber optic connector of claim 7, wherein the front housing comprises a guide fitting in front of the depressible adapter latch and the distal end portion is shaped and arranged to slidably engage the guide fitting such that the guide fitting constrains the arm to the move parallel to the longitudinal axis as the remote release member is displaced from the forward position to the rear position.

9. The fiber optic connector of claim 8, wherein the guide fitting defines a dovetail groove and the distal end portion defines tongue fitting in the dovetail groove.

10. The fiber optic connector of claim 3, wherein the collar portion has a top wall, a bottom wall opposite the top wall, a first side wall, and a second side wall, the resilient flap comprising a first resilient flap cantilevered from the first side wall and a second resilient flap cantilevered from the second side wall.

11. The fiber optic connector of claim 10, wherein the remote release member further comprises an upper boot coupling extending rearward from the top wall of the collar portion and a lower boot coupling extending rearward from the bottom wall of the collar portion.

12. The fiber optic connector of claim 11, further comprising a strain relief boot comprising an upper boot latch coupled to the upper boot coupling and a lower boot latch coupled to the lower boot latch to attach the strain relief boot to the remote release member so that pulling on the strain relief boot displaces the remote release member from the forward position to the rear position.

13. The fiber optic connector of claim 1, wherein the housing assembly comprises a top wall portion, a bottom wall portion, and a height extending from the top wall portion to the bottom wall portion, the housing assembly further comprising a first side wall portion, a second side wall portion, and a width extending from the first side wall portion to the second side wall portion, the height being greater than the width.

14. The fiber optic connector of claim 13, wherein the top wall portion comprises an upper rail having an upper rail width and an upper rail height and wherein bottom wall portion comprises a lower rail having a lower rail width and a lower rail height, the lower rail width being less than the upper rail width and the upper rail width being less than the width of the housing assembly, the lower rail height being less than the upper rail height.

15. The fiber optic connector of claim 13, wherein the ferrule is a multifiber ferrule having a front end and a rear end spaced apart along the longitudinal axis, the multifiber ferrule having a ferrule top, a ferrule bottom, a ferrule height extending from the ferrule top to the ferrule bottom, a first ferrule side, a second ferrule side, a ferrule width extending from the first ferrule side to the second ferrule side, a first longitudinal guide pin passage, a second longitudinal guide pin passage, and a plurality of fiber passages at spaced apart locations along the ferrule height, the first ferrule side defining a first forward facing shoulder and the second ferrule side defining a second forward facing shoulder in spaced apart relation with the first ferrule shoulder, the first and second forward facing shoulders configured to seat the multifiber ferrule in the optical fiber connector.

16. A fiber optic connector comprising:
a housing assembly having a front end portion and a rear end portion spaced apart along a longitudinal axis, the housing assembly comprising a top wall portion, a bottom wall portion, and a height extending from the top wall portion to the bottom wall portion, the housing assembly further comprising a first side wall portion, a second side wall portion, and a width extending from the first side wall portion to the second side wall portion, the height being greater than the width, the housing assembly including a depressible adapter latch on the top wall portion, the housing assembly comprising a depressible adapter latch having a front end portion joined to the top wall portion and a depressible portion spaced apart rearward from the front end portion;
a multifiber ferrule for terminating a plurality of optical fibers, the multifiber ferrule having a fiber alignment axis and being received in the housing assembly so that the fiber alignment axis is parallel to the height of the housing assembly; and
a push-pull boot member operably coupled to the housing assembly such that the push-pull boot member is movable in relation to the housing assembly from a forward position to a rear position to unlatch the fiber optic connector from a mating adapter, the push-pull boot member comprising a strain relief boot and an actuator arm extending forward from the strain relief boot, the actuator arm including a resiliently flexible strap having a front end portion and a rear end portion, the resiliently flexible strap being yieldably biased toward a natural orientation in which the front end portion is at a first level and the rear end portion is at a second level spaced apart below the first level, the resiliently flexible strap being configured to flex so that the front end portion moves downward toward the second level as the push-pull boot member moves from the forward position to the rear position, the front end portion configured to engage the depressible portion of the depressible adapter latch such that the front end portion depresses the depressible portion as the front end portion moves downward toward the second level.

17. The fiber optic connector of claim 16, wherein the housing assembly comprises a guide bridge comprising an upper portion, the guide bridge defining a strap slot between the upper portion and the top wall portion of the housing assembly, the flexible strap being slidably received in the strap slot, the upper portion of the guide bridge configured to bear against the flexible strap and drive the front end portion downward toward the second level as the push-pull boot member moves from the forward position to the rear position.

18. The fiber optic connector of claim 16, wherein the strain relief boot comprises a main body and a flexible slotted tube extending rearward from the main body.

19. The fiber optic connector of claim 18, wherein the push-pull boot member further comprises a push-pull tab rearwardly cantilevered from the main body and spaced apart above the flexible slotted tube.

20. A multifiber ferrule for an optical fiber connector, the multifiber ferrule comprising a ferrule body having a front end and a rear end spaced apart along a longitudinal axis, the ferrule body having a ferrule top, a ferrule bottom, a ferrule height extending from the ferrule top to the ferrule bottom, a first ferrule side, a second ferrule side, and a ferrule width extending from the first ferrule side to the second ferrule side, the ferrule body defining a first longitudinal guide pin passage, a second longitudinal guide pin passage, and a plurality of fiber passages at spaced apart locations along the ferrule height between the first longitudinal guide pin passage and the second longitudinal guide pin passage, the first ferrule side defining a first forward facing shoulder and the second ferrule side defining a second forward facing shoulder in spaced apart relation with the first ferrule shoulder, the first and second forward facing shoulders configured to seat the multifiber ferrule in the optical fiber connector.
